(19) United States
(12) Patent Application Publication
(10) Pub. No.: US 2021/0051864 A1
(43) Pub. Date: Feb. 25, 2021

(54) Insect Barrier Strip for Tree Trunks

(71) Applicant: Michael Washko, Barto, PA (US)

(72) Inventor: Michael Washko, Barto, PA (US)

(21) Appl. No.: 16/738,949

(22) Filed: Jan. 9, 2020

Related U.S. Application Data
(60) Provisional application No. 62/790,136, filed on Jan. 9, 2019.

(51) Int. Cl. A01G 13/10; A01M 1/18; A01M 1/02

(52) U.S. Cl. CPC A01G 13/105; A01M 2200/011; A01M 1/02; A01M 1/18

(57) ABSTRACT

An insect barrier strip that prevents targeted insects from climbing up a targeted tree. The insect barrier strip may contain insecticides that the targeted insects will encounter and kill. The insect barrier strip may be made of material(s) with a low coefficient of friction to provide a difficult surface for insects to traverse, that are flexible/expandable to enable the insect barrier strip to be wrapped around a tree trunk and expand over time as the trunk grows, are chemical resistant so insecticides will not degrade, and are capable of withstanding a wide range of environmental conditions. The insect barrier strip may include an overhang to make it more difficult for the targeted insects to get past. The insect barrier strip may include a trough that the insecticide can be located in or clips that insecticide can be secured to. A wick can be utilized to hold the insecticide.

### BACKGROUND

Invasive species can quickly become a major threat to native plants, animals, and agriculture businesses, since the lack of natural enemies allows them to multiply rapidly and unchecked in a non-native environment that cannot combat them naturally. This is especially true of the spotted lanternfly, that is indigenous to parts of China, India, Vietnam, and eastern Asia, which expands its wings to expose bright colors to scare away predators when threatened. The spotted lanternfly instinctively climbs trees to feed, mate, lay eggs and launch themselves over large distances towards their next intended target. The spotted lanternfly can lay between 30 and 50 eggs that are then covered with a protective waxy coating during the fall season that which require physical removal to destroy them.

Current spotted lanternfly control methods include insecticides to kill them and materials wrapped around targeted trees that they may infest to trap and kill them and/or prevent them from climbing to higher portions of the tree that they desire. Insecticides can be very effective when applied directly onto the spotted lanternflies as they kill through direct contact and absorption by the pest. If the spotted lanternflies are not treated directly, they must accumulate sufficient residual insecticide from, for example, the tree bark to be deadly. However, insecticide sprays dry quickly after which they do not transfer as readily to the insect's body and ultimately lose their effectiveness as they degraded over time. Additionally, since the spotted lanternflies crawl to the far reaches of a targeted tree, the insecticide must be sprayed indiscriminately over a very large surface area, resulting in over-use of insecticide, potential harm to native insects that form the bottom of the local food chain, and a very low pesticide kill ratio.

The materials wrapped around the targeted trees include sticky materials, such as tacky fly tape, that the spotted lanternflies get stuck to and eventually perish. Although tacky fly tape is readily available and widely used, the tape quickly loses effectiveness as it becomes covered by swarms of gnats or trapped spotted lanternflies that subsequently become stepping-stones for other spotted lanternflies to walk across. Therefore, the sticky process of removing and replacing tacky fly tape must be repeated frequently throughout the spring, summer, and fall seasons. Additionally, tacky fly tape is notorious for negatively impacting the local environment by also catching beneficial insects at the bottom of the food chain as well as native birds, bats, butterflies and other small animals. Furthermore, used tacky fly tape would contribute to unwanted landfill waste.

The materials wrapped around the trees may also include materials with minimal traction, such as plastic wrap or tin foil, materials possibly coated with Vaseline or other substances, or materials that extend outward from the trunk of the tree that the spotted lanternflies often cannot climb over. These materials may prevent the spotted lanternfly from getting to the upper portions of the tree where they often do their damage, but it does not kill the spotted lanternfly. Moreover, these materials are often not aesthetically pleasing to look at. Moreover, non-permeable materials wrapped around the tree may trap moisture and prevent air and/or sun light from drying the tree which may inadvertently damage the tree (e.g., infestation of insects attacking damp and decaying bark).

What is needed is an effective way to combat undesirable targeted insects, such as the invasive spotted lanternfly, that maintains effectiveness over an extended period of time while minimizing pesticide use and avoiding harm to the surrounding environment.

### BRIEF DESCRIPTION OF THE DRAWINGS

The features and advantages of the various embodiments will become apparent from the following detailed description in which:

FIGS. 1A-B illustrate a front view and a profile view of an example insect barrier strip, according to one embodiment;

FIG. 2 illustrates the example insect barrier strip of FIG. 1 being installed on a tree, according to one embodiment;

FIG. 3 illustrates the example insect barrier strip of FIG. 1 installed on the tree, according to one embodiment;

FIG. 4A-B illustrate a front view and a profile view of an example insect barrier strip, according to one embodiment; and

FIG. 5 illustrates the example insect barrier strip of FIG. 4 with a wick secured therein, according to one embodiment.

### DETAILED DESCRIPTION

An insect barrier strip that can be secured to a trunk of the tree and that is designed to last for many seasons and avoids harm to the surrounding environment is proposed. According to one embodiment, the insect barrier strip may prevent undesirable targeted insects, such as the invasive spotted lanternfly, from climbing up a targeted tree (reaching beyond the lowest portions thereof) as they instinctively do to feed, mate, lay eggs and launch themselves. According to one embodiment, the insect barrier strip may contain insecticides (e.g. chemical pesticides, biopesticides, horticultural oil) or the like that the targeted insects will encounter that will kill them. According to one embodiment, the insect barrier strip will both prevent the targeted insects from climbing up the tree and contain insecticides or the like that will kill the targeted insects.

The insect barrier strip may be made of a material, or materials, with a low coefficient of friction. Unlike sticky tape that attempts to hold the insect in place, a low-friction (e.g., slippery) insect barrier strip provides a difficult surface for targeted insects, such as the spotted lanternfly, to traverse while allowing native insects and animals to escape unharmed. An oily substance may be applied directly to the insect barrier strip or an insecticidal delivery device (e.g. formed material, absorbent wick) to either increase the slipperiness of the insect barrier strip or to enhance the transfer of insecticidal material to the targeted insects. The insect barrier strip may made of material(s) that are flexible enough to enable the insect barrier strip to be wrapped around a tree trunk. The insect barrier strip may be made of material(s) that are stretchable so that the insect barrier strip can stretch over time as a tree trunk girth expands. The insect barrier strip may contain a perforated strip that allows the insect barrier strip to tear in a controlled fashion as the tree trunk girth expands. The insect barrier strip may be made of material(s) that are chemical resistant so that insecticides or the like would not degrade the insect barrier strip. The insect barrier strip may be made of material(s) capable of withstanding a wide range of environmental conditions (e.g., temperature ranges, precipitation, ultraviolet light).

The insect barrier strip may be secured to the tree trunk in various fashions including, but not limited to, adhesives (e.g., tape, glue), tacks, staples, nails, or screws. Preferably the insect barrier strip will be secured to the tree in a secure manner that is least impactful to the tree during installation, use and possible removal.

If the insect barrier strip is to prevent the targeted insects from climbing up a targeted tree, as the spotted lanternfly instinctively does to feed, mate, lay eggs and launch themselves, the insect barrier strip may simply lay flat against, and be wrapped around, the tree in order to provide a slippery surface that the targeted insects will have a tough time traversing. The size of the insect barrier strip should be large enough that the insect cannot get past without encountering the slippery surface. According to one embodiment, the insect barrier strip may include overhangs, protrusions or the like that make it more difficult for the targeted insects to get past.

If the insect barrier strip is to provide insecticides or the like that the targeted insects will encounter in order to kill them, the insect barrier strip may include a means for holding the insecticide (insecticide holder) that the targeted insects will contact as they instinctively climb the targeted tree. The insecticide holder may include, but is not limited to, a trough that the insecticide can be located in or clips, hooks, pin or the like that insecticide can be secured to. According to one embodiment, a wick type material can be secured to the insect barrier strip in some fashion where the wick is utilized to hold the insecticide. The insect barrier strip may lay flat against, and be wrapped around, the tree in order to provide a slippery surface that the insects will have a tough time traversing. The size of the insect barrier strip should be large enough to constrain the insect and prolong its exposure to the insecticide.

If the insect barrier strip is to prevent the targeted insects from climbing up the targeted tree and provide insecticides or the like that the targeted insects will encounter as they attempt to climb the tree, the insect barrier strip may include both the slippery surface and the means for securing insecticide. The insect barrier strip may further include overhangs, protrusions or the like that make it more difficult for the targeted insects to get past the insect barrier strip as well as protecting the insecticides from the elements. Such a dual use insect barrier strip may be an integrated product or may be two separate products that are utilized together.

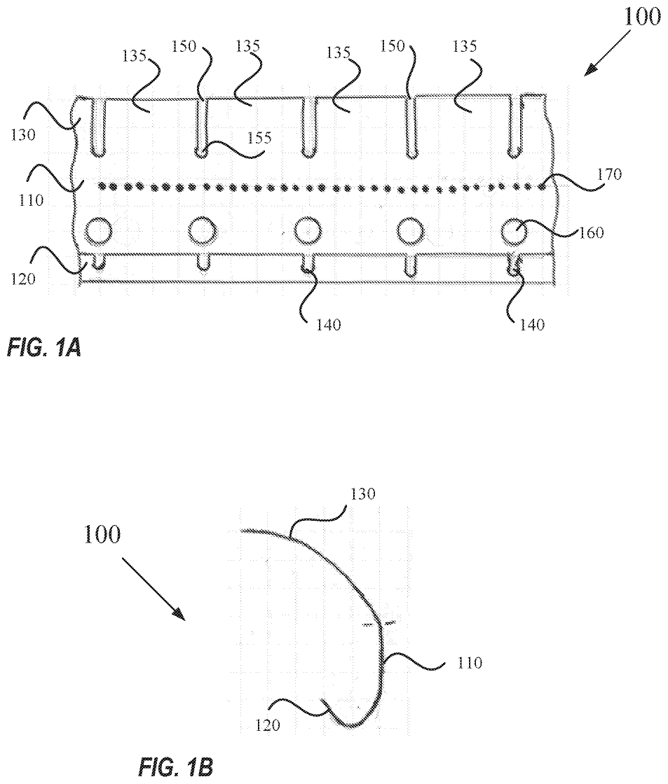

FIG. 1A-B illustrate a front view and a profile view of an example insect barrier strip 100. The insect barrier strip 100 may include a main body 110, a trough 120 and an overhang 130. The main body 110 may be configured to be secured to a target tree. The trough 120 may extend outward from the main body 110 along a lower edge thereof. The trough 120 may provide an area capable of receiving insecticides therein. The trough 120 may be deep enough to contain the insecticide but may be shallow enough to allow the targeted insects (e.g., spotted lanternfly) to gain a sufficient foothold to enter the trough 120. The trough 120 may be sufficiently tall to hold larger amounts of pesticide. In order to further ensure that the targeted insects can make their way into the trough 120 to come in contact to the insecticide the trough 120 may include cutouts 140 formed therein. The cutouts 140 provide a location where the targeted insects do not need to climb over the trough 120. The cutouts 140 are illustrated as being the same size (relatively small) and being evenly spaced apart but are not limited thereto. Rather, the cutouts 140 may be of various sizes and the spacing may vary without departing from the current scope. According, to one embodiment the cutouts 140 may be strategically located.

The insecticides may be in the form of a paste, liquid, a pre-formed solid or other suitable substance that are applied in the trough 120. The insecticides may include, but are not limited to, horticultural oils or bioinsecticides such as a suspension liquid containing Batkoa major fungal spores (spores that grow on and eventually kill the targeted insects that may be transferred to other targeted insects). According to one embodiment, an absorbent wick (not illustrated in FIGS. 1A-B) that accepts an insecticide may be placed in the trough 120. The absorbent wick may be used as an insecticide delivery device to ensure the insecticide is not inadvertently spilled from the trough 120. The insecticide held by the absorbent wick may be suspended in an oil solution to withstand weather-related moisture, which would otherwise dilute the insecticide, and enhance insecticide transfer to the intended target insects. According to one embodiment, in order to ensure the targeted insects encounter the insecticide, a bait may also be placed in or around the trough 120. The bait may be strategically located at the cutouts 140 to entice the targeted insects into the trough 120.

The overhang 130 may be formed above the main body 110. The overhang 130 may be curved with respect to (angled away from) the main body 110 as can be seen in FIG. 1B. The curved feature enables the overhang 130 to extend away from the tree when installed. The overhang 130 leverages the force of gravity to provide another obstacle for the targeted insects proceeding up the tree. Thus, the spotted lanternfly and other trunk crawling pests may be contained to an easily accessible area of the trunk where periodic insecticide spray applications may be concentrated to maximize the kill ratio with minimal insecticide use. Furthermore, the overhang 130 may cause the insects that have already passed the trough 120 to slide back into the trough 120 and again contact the insecticide contained therein. Those targeted insects that inadvertently fall off the insect barrier strip 100 (e.g., out of the trough 120, off the main body 110, off the overhang 130) may repeatedly re-climb the trunk and re-expose themselves to the insecticide until they perish.

In addition, the overhang 130 may protect the trough 120 and the insecticide contained therein from external elements, including being washed-out by rainfall. The protection may prolong the effectiveness of the insecticide in killing trunk-climbing pests. As such, the insect barrier strip 100 will yield a better kill ratio relative to both tacky strips and indiscriminate insecticide spraying.

As illustrated in FIG. 1A, the overhang 130 may include a plurality of slits 150 therein to help the 3-dimensional overhang 130 to flex and conform to the radius of the tree. According to one embodiment, the slits 150 may terminate at rounded stress-relief features 155 within the main body 110 to prevent ripping or tearing thereof. The slits 150 may divide the overhang 130 into sections 135.

According to one embodiment, the main body 110 may include a plurality of holes 160 formed therein. The holes 160 may expose sections of the bark of the tree to the environment, allowing those sections to dry out. The ability for the bark to dry may minimize the chance that other undesirable pests will attack damp and decaying bark underneath the insect barrier device 100 as may occur when utilizing wax paper, plastic wrap, tin foil, tacky fly tape or the like that completely cover wide swaths of bark. Furthermore, the holes 160 may provide access points for the spotted lanternfly to grasp the tree bark in order climb into the trough 120.

The holes 160 are illustrated as being the same size, evenly spaced apart and at the same height but are not limited thereto. Rather, the holes 160 may be configured in various fashions and have various sizes, or may be excluded altogether, without departing from the current scope. For example, if the main body 110 is sufficiently thin, bark dampness is not a concern and/or the targeted insects are small enough that they may easily escape the insect barrier trap 100 through the holes 160, the holes 160 may be excluded.

According to one embodiment, the main body 110 may include an expansion means 170 to enable the insect barrier strip 100 to automatically expand as the tree it is located on grows. As illustrated, the expansion means 170 includes a plurality of small holes located in close proximity to one another and aligned to form a continuous strip. The continuous strip of small holes 170 may provide a strategically placed “weak link” in the main body 110 that acts as a tear strip for tree girth expansion over extended periods of time. The expansion means 170 is in no way intended to be limited to the continuous strip of small holes illustrated. Rather, various expansion means could be utilized without departing from the current scope. For example, a plurality of slots could be utilized to allow for expansion.

The continuous strip of small holes 170 is illustrated along an upper part of the main body 110 near the overhang 130 but is in no way intended to be limited thereto. Rather, the continuous strip of small holes 170 could be located anywhere on the main body 110 without departing from the current scope. For example, the continuous strip of small holes 170 may be located further away from the overhang 130 (e.g., placed near the trough 120) to ensure the targeted insects cannot utilize the continuous strip of small holes 170 as a foothold to possibly get past the overhang 130

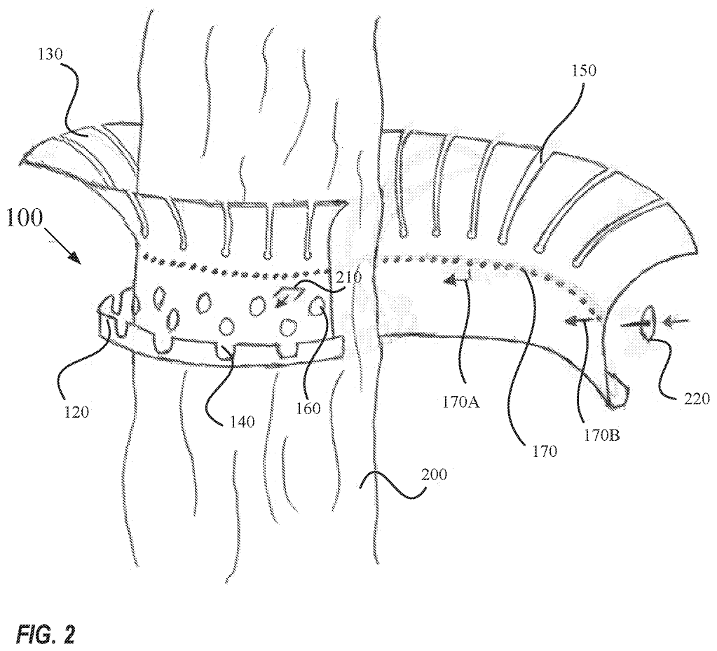

FIG. 2 illustrates the example insect barrier strip 100 being installed on a targeted tree 200. A first end of the insect barrier strip 100 may be secured to the tree 200 by placing, for example, a staple 210 through a solid section of the main body 110 into the tree 200. The insect barrier strip 100 may then be completely wrapped around the tree 200 with a second end overlapping the first end to allow for expansion. The insect barrier strip 100 may be secured to the tree 200 near a beginning of the overlapping section by placing, for example, a tack 220 through an appropriate hole 170A in the expansion means 170 (continuous strip of small holes). The constraining forces offered by the overhang 130 and the trough 120 may act to hold the remaining overlapping section in place.

As the tree expands, the main body 110 may stretch until the material between the holes 170 gives (e.g., tears) and the tack 220 moves from the initial hole 170A to other holes located in the overlapping section until it gets to an end thereof (e.g., hole 170B at end of overlap). As illustrated, only a single staple 210 and a single tack 220 are utilized to secure the insect barrier strip 100 to the tree 200. The securing of the insect barrier strip 100 is not intended to be limited to the illustrated embodiment. Rather, any number of staples 210, tacks 220 (or other suitable items such as nails or screws) could be used without departing from the current scope.

The use of the expansion means 170 results in a resilient insect barrier strip 100 with very long-lasting effectiveness that only needs to be replaced when the tree's girth growth over time exceeds the amount of overlap in the insect barrier strip 100 or exceeds the length of the expansion means 170 (e.g., breaks through an end thereof).

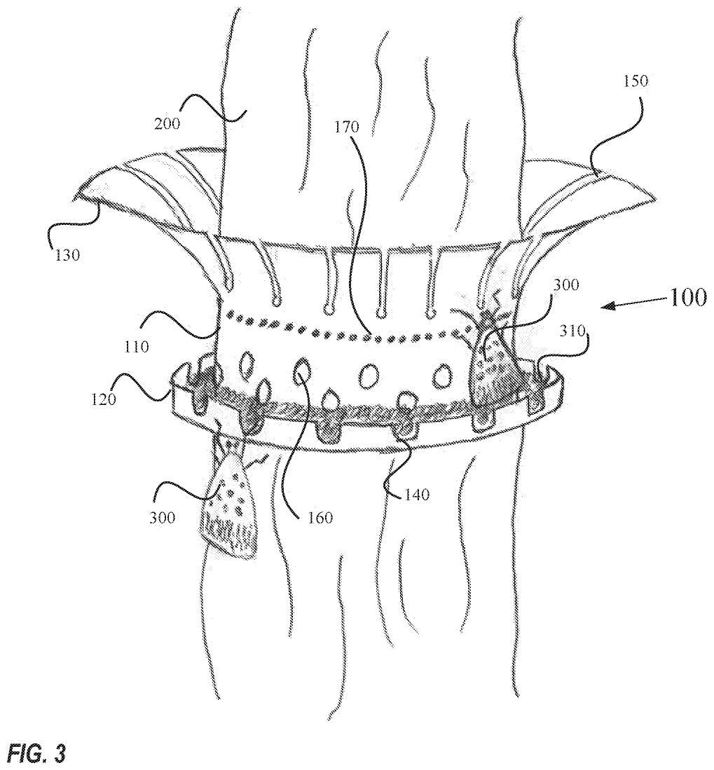

FIG. 3 illustrates the example insect barrier strip 100 installed on the tree 200. As illustrated, when installed the trough 120 is located at the bottom of the insect barrier strip 100 and extends away from the tree 200. The trough 120 is narrow and low enough that targeted insects, such as the spotted lanternflies 300, can traverse thereover as they attempt to continue to climb the tree 200. In addition, the cutouts 140 provide locations where the spotted lanternflies 300 can enter the trough 120 therethrough. As the spotted lanternflies 300 traverse the trough 120 their legs and abdomen may contact the insecticide 310 located in the trough 120. As the spotted lanternflies 300 attempt to climb the main body 110 of the insect barrier strip 100 the slippery nature thereof will make it difficult to continue to progress over the tree. As the spotted lanternflies 300 slide down the main body 110 they may continuously re-enter the trough 120 and contact the insecticide 310.

As illustrated, when installed the overhang 130 is located at the top of the insect barrier strip 100 and extends away from the tree 200. As previously described, the overhang 130 provides another obstacle for the targeted insects proceeding up the tree. Thus, the spotted lanternfly and other trunk crawling pests may be limited to areas below the insect barrier strip 100 where insecticide spray applications may be easy to apply and/or egg masses are more easily removed. Furthermore, the overhang 130 may cause the insects to slide back into the trough 120 or fall off the insect barrier strip 100 so that the targeted insects need to re-climb the trunk. Either way the targeted insects are re-exposed to the insecticide. In addition, the overhang 130 may protect the trough 120 and the insecticide contained therein from external elements, including being washed-out by rainfall.

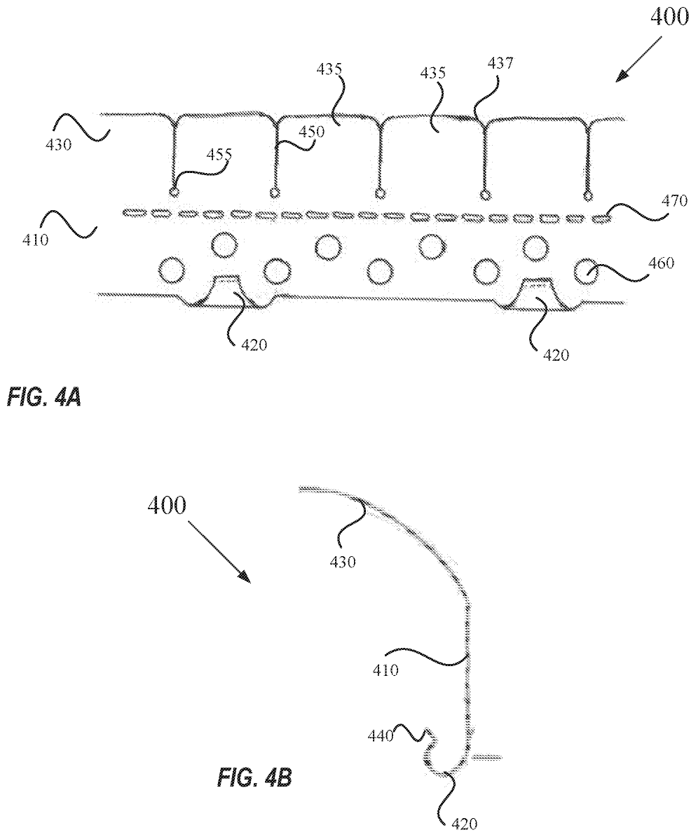

FIG. 4A-B illustrate a front view and a profile view of an example insect barrier strip 400. The insect barrier strip 400 may include a main body 410, a plurality of clips 420 and an overhang 430. The plurality of clips 420 may extend outward from the main body 110 along a lower edge thereof. The plurality of clips 420 may be capable of securing an insecticidal delivery device (not illustrated). The insecticidal delivery device may be, for example, a preformed insecticide-laced material or an absorbent wick that accepts an insecticide. According to one embodiment, in order to ensure the targeted insects encounter the insecticide, a bait may also be secured to the clips 420 and/or placed on the wick. As illustrated in FIG. 4B, the clips 420 may include flanges 440 at the ends thereof to help secure the insecticidal delivery device (e.g. preformed material, absorbent wick) therein.

The overhang 430 may be formed above the main body 410 and may be curved with respect to (angled away from) the main body 410 as can be seen in FIG. 4B. The overhang 430 leverages gravity to provide another obstacle for the targeted insects proceeding up the tree. In addition, the overhang 430 may protect the insecticidal delivery device (e.g. preformed material, absorbent wick) secured by the clips 420 from external elements, including being washed-out by rainfall. The protection may prolong the effectiveness of the insecticide. The overhang 430 may include a plurality of slits 450 therein to allow the 3-dimensional overhang 430 to flex and conform to the radius of the tree. The slits 450 may terminate at round stress-relief features 455 within the main body 410 to prevent ripping or tearing thereof. The slits 450 may divide the overhang 430 into sections 435, and at least a subset of the overhang sections 435 may have rounded petal shaped ends 437 to prevent sharp edges from causing harm to local animals (e.g., squirrels) passing thereby.

The main body 410 may include a plurality of holes 460 formed therein to expose sections of the bark to the environment, allowing those sections to dry out. The size, location and orientation of the holes 460 are not limited to the those illustrated. Rather, the holes 460 may be configured in various fashions and have various sizes, or may be excluded altogether, without departing from the current scope.

According to one embodiment, the main body 410 may include an expansion means 470 to enable the insect barrier strip 400 to expand as the tree it is located on grows. As illustrated, the expansion means 470 includes a plurality of horizontal slots that tacks, staples or the like that are used to secure the insect barrier strip 400 to the tree can move within. The expansion means 470 is in no way intended to be limited to the horizontal slots illustrated or to the location illustrated. Rather, various expansion means could be utilized, and the expansion means could be located in various locations, without departing from the current scope.

According to one embodiment, the clips 420 may also act to support a protective cover (not illustrated) for the insecticidal delivery device (e.g. preformed material, absorbent wick) to prevent unintended exposure to humans, small animals and others. Alternatively, a protective cover may be hung from the round stress relief features 455 by a support wire or other means.

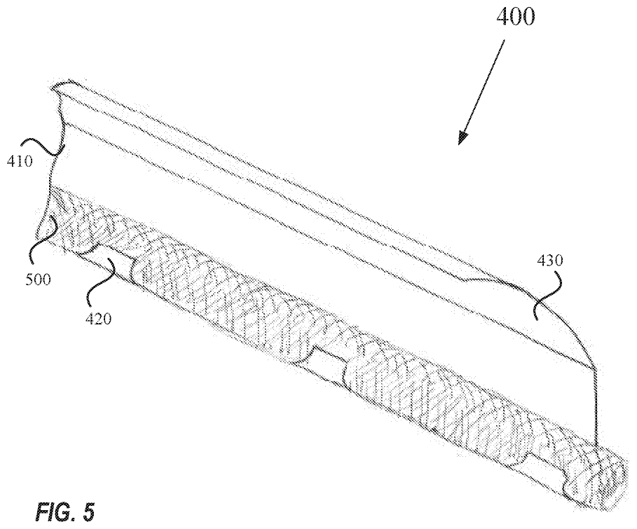

FIG. 5 illustrates the example insect barrier strip 400 having an absorbent wick 500 secured therein. It should be noted that for ease of illustration the insect barrier strip 400 does not include the slits 450, the plurality of holes 460 or the expansion means 470. The absorbent wick 500 may be saturated with the insecticidal agent. The absorbent wick 500 may ensure the insecticide can withstand weather-related moisture that would otherwise dilute the insecticide and enhance insecticide transfer to the intended target insects. According to one embodiment, the absorbent wick 500 may also be saturated with an oil-like substance. In this application, the purpose of the oil-like substance includes, but is not limited to, enhancing the slipperiness of the insect barrier strip 400, enhancing insecticide transfer to the intended target and extending effectiveness of the product by enhancing the ability of the insecticide to withstand weather-related moisture that would otherwise dilute the insecticide.

As previously noted, the insecticide contained in the insect barrier strip 100, 400 may be a transmissible infection/biological insecticide (e.g., Batkoa major fungal spores). In such cases it may be desirable to let the targeted insects escape after being infected to infect other targeted insects. According to one embodiment, the overhangs 130, 430 may have openings formed therein to allow the targeted insects to pass. The openings may be formed by, for example, selectively de-populating certain overhang sections 135, 435 or by suppressing them with a piece of material. Targeted insects encountering the insect barrier strip 100, 400 would be delayed within the confines of the insect barrier strip 100, 400 long enough to acquire the fungal spores but ultimately allowed to escape so the target insects may transfer the acquired fungal spores to other target insects. This application may increase the kill rate far beyond the number of pests that directly enter the insect barrier strip 100, 400. Wide-area coverage may then be attained with a limited number of strategically placed tree trunk barrier strips over a geographic area that contain the transmissible agent.

According to one embodiment, the overhang 130, 430 may be made with thinner and/or more flexible material(s) and may be designed with the rounded petal shaped ends 437 to allow passage of local animals (e.g., squirrels) with minimal harm. Alternatively, the overhang 130, 430 may be made with thicker and/or less flexible material(s) to prevent passage of unwanted animals (e.g., squirrels).

According to one embodiment, the insect barrier strip 100, 400 may also be stretched about a pre-determined diameter during manufacture to minimize the number and proximity of the slits 150, 450 in the overhang 130, 430 and to further facilitate application to tree trunks. Furthermore, several pre-determined “stretch diameters” may be chosen to target specific ranges of tree girth applications (e.g., <6-inch diameter, 6″ to 12″ diameter).

According to one embodiment, the insect barrier strip may be manufactured in separate upper and lower parts (e.g., lower part providing trough 120, 420, upper part providing overhang 130, 430) where each section may have its own expansion means 170, 470. The upper overhang section may be utilized individually for applications where containing the targeted pest to the lower trunk and periodic insecticide spray applications are sufficient. The lower trough section may be utilized individually for applications where contact with insecticide but not containment is desired (e.g., in cases where fungal spores are utilized as the insecticide). When both containment and insecticide contact are desired both the upper and lower parts may be secured to the tree.

According to one embodiment, the insect barrier strip may include a manual expansion means rather than the automatic expansion means 170, 470 described above. The insect barrier strip may include alternating pegs and holes formed along the main body that may be used to secure overlapping portions of the insect barrier strip together and to secure the insect barrier strip to a tree. The insect barrier can be manually expanded by removing one or more pegs from one or more holes and moving to a new hole that provides less overlap and a larger circumference. Such a design may better accommodate slim tree trunks and slow-growing trunks, such as grape vines, in which there is little room for multiple tacks and/or the resulting damage to the trunk or vine is undesirable.

The insect barrier strip has been described above as being located on targeted trees but is not limited thereto. For example, the insect barrier strip with bait to attract the target insects may be affixed to an artificial structure that may be placed around the targeted trees (e.g., small tree trunks or grape vines). The artificial structure may also be placed in a strategic location to draw pests away from specific areas. Such protected areas may include, but are not limited to, personal outdoor living spaces such as patios and porches, tree-covered public areas such as children's playgrounds, and agricultural areas such as vineyards and orchards, and campgrounds. This feature allows the landowner to further minimize pests' nuisance and damage by attracting them to a more favorable location where the unsightly attacking swarm and the resulting dead bodies of the pests are least problematic.

Although the invention has been illustrated by reference to specific embodiments, it will be apparent that the invention is not limited thereto as various changes and modifications may be made thereto without departing from the scope. Reference to “one embodiment” or “an embodiment” means that a particular feature, structure or characteristic described therein is included in at least one embodiment. Thus, the appearances of the phrase “in one embodiment” or “in an embodiment” appearing in various places throughout the specification are not necessarily all referring to the same embodiment.

The various embodiments are intended to be protected broadly within the spirit and scope of the appended claims.

What is claimed is:

1. An insect barrier strip comprising
a main body configured to be wrapped around, lay substantially flush against, and be secured to an object, wherein the main body provides a low-friction surface that is difficult for targeted insects to climb;
an insecticide holder extending from a lower edge of the main body to hold insecticide that the targeted insects come in contact with as they climb thereover on their way up the object; and
an overhang extending from an upper edge of the main body that curves away from the main body and leverages gravity to provide an obstacle for the targeted insects proceeding up the object and protects the insecticide holder and the insecticide held therein from external elements.

2. The insect barrier strip of claim 1, wherein the object is a tree trunk.

3. The insect barrier of claim 1, wherein the object is an artificial and relocatable structure.

4. The insect barrier of claim 1, wherein the targeted insects are trunk crawling insects.

5. The insect barrier strip of claim 1, wherein the insecticide holder is a trough.

6. The insect barrier strip of claim 5, wherein the trough includes cutouts configured to provide the targeted insects access into the trough.

7. The insect barrier strip of claim 1, wherein the insecticide holder includes a plurality of clips that secure an insecticidal delivery device thereto.

8. The insect barrier strip of claim 7, wherein the insecticide delivery device includes some subset of a preformed insecticide-laced material and an absorbent wick that accepts an insecticide.

9. The insect barrier strip of claim 1, wherein an oily substance is applied thereto to increase the slipperiness of the insect barrier strip, enhance transfer of the insecticide to the targeted insects, or both.

10. The insect barrier strip of claim 1, wherein the main body includes one or more holes formed therein, wherein the one or more holes is to enable the object to be exposed to the environment or to provide one or access points for the targeted insects to grasp the object instead of the low-friction surface to aid the targeted insects in climbing.

11. The insect barrier strip of claim 1, wherein the main body includes an expansion means to automatically expand as the object it is located on grows.

12. The insect barrier strip of claim 11, wherein the expansion means includes a plurality of small holes located in close proximity to one another and aligned to form a continuous strip of small holes that provide a strategically placed “weak link” that acts as a tear strip.

13. The insect barrier strip of claim 11, wherein the expansion means includes a plurality of vertically aligned slots that a connector used to secure the main body to the object can traverse.

14. The insect barrier strip of claim 1, wherein the main body includes a plurality of alternating pegs and holes configured to enable one end of the main body to be secured to another end of the main body in order to secure the insect barrier strip to the object.

15. The insect barrier strip of claim 1, wherein the insecticide holder is further to hold targeted insect bait.

16. The insect barrier strip of claim 1, further comprising a protective cover for the pesticidal delivery device.

17. The insect barrier strip of claim 1, wherein the overhang includes openings therein to allow the targeted insect a means of escape.

18. The insect barrier strip of claim 1, wherein the insecticide is a biological insecticide such as Batkoa major fungal spores that may be transferred from infected targeted insect to other targeted insects external to the insect barrier strip.

19. The insect barrier strip of claim 1, wherein outer edges of the overhang may be rounded to minimize harm to native animals as they pass over the insect barrier strip.

20. The insect barrier strip of claim 1, wherein the overhang includes a plurality of vertical slits that provide lateral flexibility for application to various size objects.
